(19) United States
(12) Patent Application Publication
(10) Pub. No.: US 2025/0125076 A1
(43) Pub. Date: Apr. 17, 2025

(54) Soft Magnetic Powder, Dust Core, Magnetic Element, And Electronic Device

(71) Applicant: SEIKO EPSON CORPORATION, Tokyo (JP)

(72) Inventors: Toshiki SANO, Hachinohe (JP); Yuto OKUDERA, Hachinohe (JP); Junya ABE, Hachinohe (JP)

(21) Appl. No.: 18/911,369

(22) Filed: Oct. 10, 2024

(30) Foreign Application Priority Data
Oct. 11, 2023 (JP) 2023-175891

(51) Int. Cl. H01F 1/147; C22C 38/00; C22C 38/02; C22C 38/18; H01F 27/24

(52) U.S. Cl. CPC H01F 1/14766; C22C 38/008; C22C 38/02; C22C 38/18; H01F 27/24; C22C 2202/02

(57) ABSTRACT

A soft magnetic powder includes Fe as a main component; Si having a content of 2.5% or more by mass and 7.5% or less by mass; Cr having a content of 1.0% or more by mass and 10.0% or less by mass; Sn having a content of 0.05% or more by mass and 1.10% or less by mass; and impurities, wherein an average particle size is 2.0 μm or more and 10.0 μm or less and an average circularity of particles is 0.80 or more and 0.95 or less.

The present application is based on, and claims priority from JP Application Serial Number 2023-175891, filed Oct. 11, 2023, the disclosure of which is hereby incorporated by reference herein in its entirety.

### BACKGROUND

### 1. Technical Field

The present disclosure relates to a soft magnetic powder, a dust core, a magnetic element, and an electronic device.

### 2. Related Art

JP-A-2008-124270 discloses a soft magnetic powder having a composition represented by Fe-2% Si-1% Cr-1% Sn and having the average particle size of 55 μm or 200 μm. In this soft magnetic powder, the crystal grain size is optimized. This makes it possible to realize a dust core having a low core loss when excited at a predetermined excitation frequency.

Since the particle size of the soft magnetic powder described in JP-A-2008-124270 is large, there is a problem that the eddy current loss is high when the soft magnetic powder is used for a dust core. There is also a problem that the magnetic characteristic of a dust core is lowered because the filling property at the time of powder compaction is low.

Therefore, it is an object to realize a soft magnetic powder which is excellent in filling property even when the particle size is small and can produce a dust core having a low iron loss and good magnetic characteristic.

### SUMMARY

A soft magnetic powder according to an application example of the present disclosure includes Fe as a main component; Si having a content of 2.5% or more by mass and 7.5% or less by mass; Cr having a content of 1.0% or more by mass and 10.0% or less by mass; Sn having a content of 0.05% or more by mass and 1.10% or less by mass; and impurities, wherein an average particle size is 2.0 μm or more and 10.0 μm or less and an average circularity of particles is 0.80 or more and 0.95 or less.

A dust core according to an application example of the present disclosure includes the soft magnetic powder according to an application example of the present disclosure.

A magnetic element according to an application example of the present disclosure includes the dust core according to an application example of the present disclosure.

An electronic device according to an application example of the present disclosure includes the magnetic element according to an application example of the present disclosure.

### BRIEF DESCRIPTION OF THE DRAWINGS

FIG. 1 is a plan view schematically showing a toroidal type coil part.

FIG. 2 is a transparent perspective view schematically showing a closed magnetic circuit type coil part.

FIG. 3 is a perspective view showing a mobile type personal computer, which is an electronic device including a magnetic element according to an embodiment.

FIG. 4 is a plan view showing a smartphone, which is an electronic device including a magnetic element according to an embodiment.

FIG. 5 is a perspective view showing a digital still camera, which is an electronic device including a magnetic element according to an embodiment.

### DESCRIPTION OF EMBODIMENTS

Hereinafter, a soft magnetic powder, a dust core, a magnetic element, and an electronic device of the present disclosure will be described in detail based on preferred embodiments shown in the accompanying drawings.

### 1. Soft Magnetic Powder

A soft magnetic powder according to an embodiment is a metal powder exhibiting soft magnetism. Such soft magnetic powder is applicable to any application, for example, particles are bound to each other via a binder, it is used to produce various green compacts such as a dust core and an electromagnetic wave absorbent material.

### 1. 1. Composition

A soft magnetic powder consists of Fe (iron) as a main component, Si (silicon) having a content of 2.5% or more by mass and 7.5% or less by mass, Cr (chromium) having a content of 1.0% or more by mass and 10.0% or less by mass, Sn having a content of 0.05% or more by mass and 1.10% or less by mass, and impurities.

A main component refers to an element with the highest content rate in terms of atomic ratio. Fe is a main component of a soft magnetic powder and has a great influence on the magnetic characteristic of a soft magnetic powder.

The content rate of Fe is not particularly limited, but is desirably 80% or more by mass, and more desirably 90% or more by mass.

The content rate of Si is set to 2.5% or more by mass and 7.5% or less by mass, but is desirably 2.7% or more by mass and 5.0% or less by mass, and more desirably 3.0% or more by mass and 4.5% or less by mass. When the content rate of Si is within the above ranges, a green compact with higher magnetic permeability can be obtained. When the content rate of Si is below the lower limit value, the magnetic characteristics such as the magnetic permeability and the direct current superposition characteristic decrease. On the other hand, when the content rate of Si exceeds the upper limit value, a soft magnetic powder becomes hard, and thus the density of a green compact decreases.

The content rate of Cr is set to 1.0% or more by mass and 10.0% or less by mass, but is desirably 3.0% or more by mass and 6.0% or less by mass, more desirably 4.0% or more by mass and 5.0% or less by mass. When the content rate of Cr is within the above ranges, it is possible to enhance the oxidation resistance of a soft magnetic powder. This allows the oxide occupancy rate to be kept particularly low during powder compaction, and a soft magnetic powder is obtained that can be used to produce a green compact having good magnetic characteristics such as the magnetic permeability and the direct current superposition characteristic. When the content rate of Cr is below the lower limit value, the oxidation resistance of a soft magnetic powder decreases. On the other hand, when the content rate of Cr exceeds the upper limit value, the magnetic characteristics such as the magnetic permeability and the direct current superposition characteristic decrease.

The content rate of Sn is set to 0.05% or more by mass and 1.10% or less by mass, but is desirably 0.07% or more by mass and 0.80% or less by mass, more desirably 0.10% or more by mass and 0.40% or less by mass. When the content rate of Sn is within the above ranges, the particle shape of a soft magnetic powder can be made closer to a spherical shape. By this, even when the particle size is small, the filling property of a soft magnetic powder can be enhanced, and the density of a green compact can be increased. When the content rate of Sn is below the lower limit value, the circularity of the particle shape is lowered, and the filling property is lowered. Therefore, the density of a green compact is reduced, and the magnetic characteristics such as the magnetic permeability and the direct current superposition characteristic are reduced. On the other hand, when the content rate of Sn exceeds the upper limit value, a soft magnetic powder is easily oxidized, and the oxygen content rate increases. Oxides generated with oxidation reduce the occupancy rate of metals in a green compact, leading to a decrease in the density of a green compact, and the magnetic characteristics such as the magnetic permeability and the direct current superposition characteristic decrease.

The mass ratio of content of Sn to content of Cr is defined as Sn/Cr. The mass ratio Sn/Cr is desirably 0.02 or more and 0.30 or less, more desirably 0.03 or more and 0.25 or less, and more desirably 0.04 or more and 0.20 or less. When the mass ratio Sn/Cr is within the above ranges, the balance between the Cr content and the Sn content can be optimized. This makes it possible to achieve both an improvement in the filling property due to the particle shape and an improvement in the magnetic characteristic due to the optimization of the composition. As a result, green compact having particularly good magnetic characteristic can be obtained.

When the mass ratio Sn/Cr is below the lower limit value, although the oxidation resistance of a soft magnetic powder is improved, the circularity of the particle shape is lowered, and there is a possibility that the filling property of a soft magnetic powder is lowered. On the other hand, when the mass ratio Sn/Cr exceeds the upper limit value, although the spheroidization of a soft magnetic powder is achieved, the oxidation resistance is reduced, and there is a possibility that the occupancy rate of metals in a green compact is reduced.

A soft magnetic powder may contain other elements as impurities in addition to the above-described elements. Impurity refers to an element other than the above-described elements, which is an inevitably contaminate.

The concentration of impurities is desirably 0.10% or less by mass for each element, more desirably 0.05% or less by mass. The total concentration of impurities is desirably 1.00% or less by mass. Within this range, even when other elements are contained, they do not affect the effects exhibited by a soft magnetic powder, and thus the inclusion thereof is allowable.

A soft magnetic powder according to the embodiment may contain oxygen as an impurity. Oxygen may be introduced as a raw material or during a manufacturing process. The oxygen content rate of a soft magnetic powder is desirably 3000 ppm or less, more desirably 2000 ppm or less, and still more desirably 1500 ppm or less in terms of mass ratio. Thus, since the deterioration of the particle shape due to surface deposit of oxides is suppressed, a soft magnetic powder having high filling property during powder compaction is obtained. It is possible to suppress a decrease in the occupancy rate of metal in a green compact. On the other hand, the lower limit value may not be set, but from the viewpoint of securing the insulating property between particles, the lower limit value of the oxygen content rate is desirably 300 ppm or more, and more desirably 500 ppm or more. By this, it is possible to sufficiently ensure the insulation between the particles, it is possible to obtain a green compact in which the eddy current loss is suppressed.

The above-described composition is specified by the following analysis method.

Examples of analysis methods include iron and steel—atomic absorption spectrometry specified in JIS G 1257:2000, iron and steel—ICP emission spectroscopy specified in JIS G 1258:2007, iron and steel—spark discharge emission spectroscopy specified in JIS G 1253:2002, iron and steel—X-ray fluorescence analysis method specified in JIS G 1256:1997, and weight method, titration method, and absorptiometric method specified in JIS G 1211 to G 1237.

Specific examples thereof include a solid-state emission spectrometer manufactured by SPECTRO Corporation, particularly a spark discharge emission spectrometer, model: SPECTROLAB, type: LAVMB08A, and an ICP device CIROS 120 manufactured by Rigaku Corporation.

In particular, when C (carbon) and S (sulfur) are specified, the combustion in an oxygen stream (high-frequency induction heating furnace combustion)-infrared absorption method specified in JIS G 1211:2011 is also used. Specific examples thereof include the carbon-sulfur analyzer CS-200 manufactured by LECO Corporation.

Further, in particular, when N (nitrogen) and O (oxygen) are specified, the method for quantitative determination of nitrogen in iron and steel specified in JIS G 1228:1997 and the general rule for the quantitative determination of oxygen content in metal materials specified in JIS Z 2613:2006 are also used. Specific examples thereof include an oxygen-nitrogen analyzer manufactured by LECO Corporation, TC-300/EF-300, and an oxygen-nitrogen-hydrogen analyzer ONH836 manufactured by LECO Corporation.

### 1. 2. Powder Characteristic

The average particle size of a soft magnetic powder is set to 2.0 μm or more and 10.0 μm or less, desirably 3.0 μm or more and 10.0 μm or less, and more desirably 4.0 μm or more and 9.0 μm or less. By this, a soft magnetic powder having a high filling property at the time of powder compacting and capable of suppressing eddy current loss in a green compact is obtained.

When the average particle size of a soft magnetic powder is below the lower limit value, the soft magnetic powder is easily aggregated, the filling property decreases, and the density of the green compact decreases. On the other hand, when the average particle size of a soft magnetic powder exceeds the upper limit value, eddy current loss of a green compact may increase.

Note that average particle size refers to a particle size D50 at which the cumulative frequency is 50% from a small diameter side in the volume-based cumulative particle size distribution of a soft magnetic powder obtained using a laser diffraction particle size distribution measuring device.

The average circularity of a soft magnetic powder is 0.80 or more and 0.95 or less, desirably 0.82 or more and 0.92 or less, and more desirably 0.85 or more and 0.90 or less. By this, a soft magnetic powder having particularly good filling property at the time of powder compacting is obtained. When an insulation coating is formed on the particle surface of a soft magnetic powder, the coating can be uniformly formed without unevenness. By this, it is possible to produce a green compact having excellent insulation between particles. By forming a coating uniformly and without unevenness, the specific surface area can be reduced, which also allows for a reduction in the binder amount covering the surface. Therefore, since the amount of binder required to bind between particles is reduced, it is possible to enhance the magnetic characteristic of a green compact.

When the average circularity is below the lower limit value, the filling property during powder compaction of a soft magnetic powder is reduced. The uniformity of the coating thickness of an insulation coating is reduced. On the other hand, when the average circularity exceeds the upper limit value, the production difficulty of a soft magnetic powder increases.

The average circularity of a soft magnetic powder is measured as follows.

First, an image of a soft magnetic powder (secondary electron image) is captured by a scanning electron microscope (SEM). Next, the obtained image is read into image processing software. As the image processing software, for example, image analysis type particle size distribution measurement software “Mac-View” manufactured by Mountech Co., Ltd. is used. The imaging magnification is adjusted so that 50 or more and 100 or less particles are captured in one image. Then, a plurality of images is acquired so that a total of 300 or more particle images are obtained.

Next, the circularity of the 300 or more particle images is calculated using software, and the average value is obtained. The obtained average value is the average circularity of the soft magnetic powder. Assuming that the circularity is e, the area of the particle image is S, and the circumferential length of the particle image is L, the circularity e is obtained by the following equation.

e=4πS/L²

Particles of a soft magnetic powder may include a plurality of crystal grains. That is, the particles of a soft magnetic powder may include a polycrystalline structure. The number of crystal grains per unit area of a cross section of a particle is desirably 0.10 [grains/(μm)²] or more and 0.45 [grains/(μm)²] or less, more desirably 0.14 [grains/(μm)²] or more and 0.38 [grains/(μm)²] or less, and still more desirably 0.16 [grains/(μm)²] or more and 0.35 [grains/(μm)²] or less. When the number of crystal grains per unit area of a cross section of a particle is within the above ranges, the number density of the crystal grains can be optimized, and as a result, the crystal grain size can be optimized. By this, particles are appropriately deformed at the time of powder compacting, and a soft magnetic powder capable of producing a high-density green compact is obtained. The magnetic permeability depending on the crystal grain size is sufficiently high, and a soft magnetic powder with low eddy current loss can be obtained.

The number of crystal grains per unit area of a cross section of a particle of a soft magnetic powder is measured as follows.

First, a cross section of a particle of a soft magnetic powder is corroded with a 3% nital etchant (nitric acid 3%, ethanol 97%). Next, a cross section image of a particle is captured by a scanning transmission electron microscope (STEM). Next, the obtained image is read into image processing software. As the image processing software, for example, image analysis type particle size distribution measurement software “Mac-View” manufactured by Mountech Co., Ltd. is used.

Next, the area of a cross section (cross-sectional area) of the particle is calculated. The cross-sectional area is calculated using a calculation formula (cross-sectional area=major axis×minor axis×π÷4) after calculating a major axis and a minor axis of a cross section.

Image processing software detects crystal grains included in the image of the cross section. Next, the number of crystal grains included in the cross section of the one particle is counted. Then, the number of crystal grains counted is divided by the cross-sectional area to calculate the number of crystal grains per unit area of the cross section (number density of crystal grains). The unit is grains/(μm)².

### 1. 3. Insulation Coating

If necessary, an insulation coating may be provided on the surface of the particles of the soft magnetic powder. By providing such an insulation coating, it is possible to enhance the insulation between particles of the soft magnetic powder. As a result, eddy current flowing between particles can be suppressed, and eddy current loss in green compact can be suppressed.

Examples of an insulation coating include a glass material, a ceramic material, and a resin material.

### 1. 4. Tapped Density and Green Compact Density

The tapped density of a soft magnetic powder is desirably 3.80 g/cm³ or more and 5.10 g/cm³ or less, more desirably 3.90 g/cm³ or more and 5.00 g/cm³ or less, and still more desirably 4.00 g/cm³ or more and 5.00 g/cm³ or less. When the tapped density is within the above ranges, a soft magnetic powder having particularly good filling property is obtained. By this, it is possible to produce a green compact having a higher density. When the tapped density is below the lower limit value, the filling property of a soft magnetic powder is reduced, and there is a possibility that the density of a green compact is reduced. On the other hand, when the tapped density exceeds the upper limit value, there is a possibility that the production difficulty of a soft magnetic powder may be increased.

The tapped density of a soft magnetic powder is measured as follows.

First, a soft magnetic powder is subjected to a coupling agent treatment. As a coupling agent, phenyltrimethoxysilane is used. Next, the tapped density of the processed soft magnetic powder is measured by a powder characteristic evaluation device. As a powder characteristic evaluation device, Powder Tester (registered trademark) PT-X manufactured by HOSOKAWA MICRON CORPORATION is used.

The density of a green compact obtained by powder compacting the soft magnetic powder at a pressure of 294 MPa is desirably 5.30 g/cm³ or more and 6.10 g/cm³ or less, and more desirably 5.50 g/cm³ or more and 6.00 g/cm³ or less. By this, a soft magnetic powder having a particularly good filling property and relatively low difficulty in production can be obtained. By this, it is possible to produce a green compact having a higher density.

### 1. 5. Specific Surface Area

The specific surface area of a soft magnetic powder is desirably 0.170 m²/g or more and 0.320 m²/g or less, more desirably 0.180 m²/g or more and 0.300 m²/g or less, and still more desirably 0.190 m²/g or more and 0.280 m²/g or less. When the specific surface area is within the above ranges, the filling property of the soft magnetic powder is improved, it is possible to increase the density of the green compact. When the specific surface area is below the lower limit value, the particle size of a soft magnetic powder is too large, there is a possibility that the iron loss of a green compact is increased. On the other hand, when the specific surface area exceeds the above upper limit value, the filling property of a soft magnetic powder is reduced, and the density of a green compact may be reduced.

The specific surface area of a soft magnetic powder is obtained by a BET method. An example of a measuring device for the specific surface area is a BET type specific surface area measuring device HM1201-010 manufactured by Mountech Co., Ltd., and the amount of a sample is set to 5 g.

### 1. 6. Magnetic Permeability

In a soft magnetic powder according to the present embodiment, the magnetic permeability of a green compact is desirably 30 or more, and more desirably 32 or more at the measurement frequency 1 MHz. With such a soft magnetic powder, it is possible to realize a high magnetic permeability green compact.

The magnetic permeability of a green compact is the real part μ′ of the complex magnetic permeability, and for its measurement, a BH analyzer is used with a measurement frequency of 1 MHz. The number of turns of a winding wire relative to a green compact is 7 times, and the diameter of the winding wire is 0.5 mm. When a green compact is produced, an epoxy resin of 2% by mass of the soft magnetic powder is used as a binder. The size of a green compact is an outer diameter φ14 mm, an inner diameter 08 mm, and a thickness of 3 mm, and the molding pressure is 294 MPa.

### 1. 7. Direct Current Superposition Characteristic

The soft magnetic powder according to the present embodiment has excellent filling property as described above, and it is possible to produce a high-density green compact. A high-density green compact has high direct current superposition characteristic. Direct current superposition characteristic generally refers to the magnetic permeability characteristic due to the direct current magnetic field applied in an alternating current circuit where a magnetic element is used, when a direct current is superimposed on the alternating current. In the present specification, when the magnetic permeability at the time when a direct current magnetic field is superimposed on an alternating current magnetic field and applied decreases by 30% from the magnetic permeability at the time when no direct current magnetic field is applied, the magnitude of the direct current magnetic field at that time is treated as the direct current superposition characteristic. If the direct current superposition characteristic according to this definition is high, high magnetic permeability can be maintained up to a high applied magnetic field. The magnetic permeability when measuring g the direct current superposition characteristic in the present specification is the real part μ′ of the complex magnetic permeability measured using a BH analyzer, with the measurement frequency set to 10 kHz.

The soft magnetic powder according to the present embodiment desirably has a direct current superposition characteristic of 15000 [A/m] or more, more desirably 16000 [A/m] or more, when formed into a green compact. A soft magnetic powder with such a direct current superposition characteristic is suitable for large current applications where a high magnetic field is applied.

### 1. 8. Coercive Force

In the soft magnetic powder according to the present embodiment, the coercive force is desirably 12.0 [Oe] or less (955 [A/m] or less), more desirably 10.0 [Oe] or less (796 [A/m] or less), and still more desirably 8.0 [Oe] or less (637 [A/m] or less). When the coercive force is within the above ranges, it is possible to suppress the hysteresis loss in the green compact. From the viewpoint of easy production of a soft magnetic powder, the coercive force is desirably 2.0 [Oe] or more (159 [A/m] or more), and more desirably 3.0 [Oe] or more (239 [A/m] or more).

The coercive force of a soft magnetic powder can be measured by a vibrating sample magnetometer or the like. The maximum applied magnetic field when the coercive force is measured is, for example, 15 kOe.

### 2. Manufacturing Method for Soft Magnetic Powder.

Next, an example of a manufacturing method of the soft magnetic powder described above will be described.

The soft magnetic powder may be a powder manufactured by any method. Examples of the manufacturing method include various atomization methods such as a water atomization method, a gas atomization method, and a rotating water flow atomization method, and a grinding method. Among these, a powder manufactured by an atomization method is desirably used as the soft magnetic powder. According to an atomization method, it is possible to efficiently manufacture a high-quality metal powder in which the particle shape is closer to a true sphere and the amount of oxides and the like formed is small. Therefore, a metal powder having a smaller specific surface area can be manufactured by an atomization method.

An atomization method is a method for manufacturing a metal powder by causing a molten metal to collide with a liquid or a gas jetted at a high speed to atomize and cool the molten metal. In an atomization method, after a molten metal is atomized, since the spheroidization proceeds in the process leading to solidification, it is possible to manufacture particles closer to a true sphere.

A water atomization method is a method for manufacturing a metal powder from a molten metal by using liquid such as water as cooling liquid, jetting the liquid in an inverted conical shape so that the liquid converges at one point, and allowing the molten metal to flow down toward the converging point to collide with the liquid.

A rotating water flow atomization method is a method for manufacturing a metal powder by supplying cooling liquid along the inner circumferential surface of a cooling cylinder, swirling the cooling liquid along the inner circumferential surface, while blowing a jet of liquid or gas onto a molten metal to introduce scattered molten metal into the cooling liquid.

A gas atomization method is a method of manufacturing metal powder from molten metal by using gas as the cooling medium, and jetting the gas in an inverted conical shape that converges at one point together with allowing molten metal to flow down toward the converging point to collide with the gas.

In these atomization methods, the number density of crystal grains in a particle cross section of a soft magnetic powder can be adjusted according to the conditions.

With respect to the melting point Tm [° C.] of the constituent material of the soft magnetic powder, the casting temperature of the melting temperature is desirably set to Tm+200° C. or more, more desirably set to Tm+220° C. or more and Tm+350° C. or less, and still more desirably set to Tm+250° C. or more and Tm+300° C. or less. By this, when a soft magnetic powder is atomized by various atomization methods and solidified, the time during which the soft magnetic powder is present as a molten metal can be ensured to be longer than that in the related art. By this, the number density of the crystal grains in a particle cross section of a soft magnetic powder can be adjusted within the above-described range.

In the atomization methods, molten metal is allowed to flow down through a narrow opening, and the resulting thin flow of the molten metal collides with a fluid jet. The outer diameter of thin flow of a molten metal is not particularly limited, but is desirably 2.5 mm or less, more desirably 0.3 mm or more and 2.0 mm or less, and still more desirably 0.5 mm or more and 1.5 mm or less. By this, the fluid jet is likely to be uniformly applied to the molten metal, and thus droplets having an appropriate size are likely to be uniformly scattered. As a result, the average particle size of the soft magnetic powder can be adjusted within the above-described range. Since the cooling speed becomes relatively fast, the oxygen content rate of a soft magnetic powder can be adjusted within the above-described range. Further, since the amount of a molten metal supplied during a certain time is suppressed, the cooling speed of each droplet also becomes uniform, and the number density of crystal grains in a particle cross section magnetic powder is easily adjusted to be within the above-described range.

A manufactured soft magnetic powder, if necessary, may be subjected to classification. Examples of classification methods include dry classification such as sieve classification, inertial classification, centrifugal classification, and wet classification such as sedimentation classification.

### 3. Dust Core and Magnetic Element

Next, a dust core and a magnetic element according to an embodiment will be described.

A magnetic element according to an embodiment can be applied to various magnetic elements including a magnetic core, such as a choke coil, an inductor, a noise filter, a reactor, a transformer, a motor, an actuator, a solenoid valve, and a generator. A dust core according to the embodiment can be applied to magnetic cores included in these magnetic elements.

Hereinafter, as an example of the magnetic element, two types of coil parts will be described as a representative.

### 3. 1. Toroidal Type

First, a description will be given of a toroidal type coil part, which is an example of a magnetic element according to an embodiment.

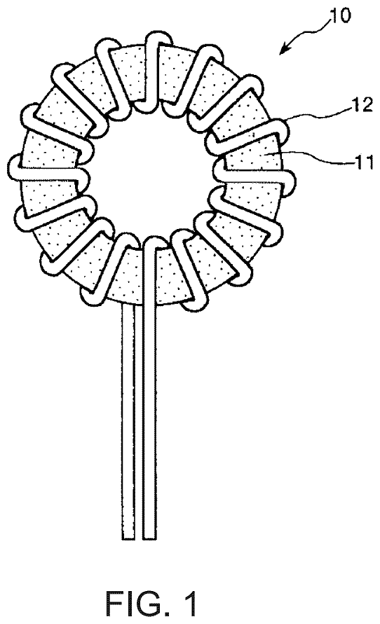

FIG. 1 is a plan view schematically showing a toroidal type coil part.

A coil part 10 shown in FIG. 1 includes a ring-shaped dust core 11 and a conductive wire 12 wound around the dust core 11. Such a coil part 10 is generally referred to as a toroidal coil.

The dust core 11 is obtained by mixing a soft magnetic powder and a binder according to an embodiment, and supplying the obtained mixture to a molding die, pressing, and molding. Therefore, the dust core 11 is a green compact containing a soft magnetic powder according to an embodiment. In such a dust core 11, even using a soft magnetic powder having a small diameter, since the filling property is enhanced, it becomes high density with low iron loss. Therefore, when the coil part 10 is mounted on an electronic device or the like, the electronic device or the like can be improved in performance and reduced in size.

Examples of a constituent material of a binder used in the production of the dust core 11 include organic materials such as silicone based resin, epoxy based resin, phenol based resin, polyamide based resin, polyimide based resin, polyphenylene sulfide based resin, and inorganic materials such as phosphates such as magnesium phosphate, calcium phosphate, zinc phosphate, manganese phosphate, and cadmium phosphate, and silicates such as sodium silicate. In particular, thermosetting polyimide or epoxy based resin is desirable. These resin materials are easily cured by being heated and have excellent heat resistance. Therefore, the manufacturing easiness and heat resistance of the dust core 11 can be enhanced.

The ratio of a binder to a soft magnetic powder, the magnetic characteristic and mechanical characteristic of the dust core 11 to be manufactured, may vary slightly depending on the allowable eddy current loss, and the like, but it is desirable to be about 0.3% or more by mass and 5.0% or less by mass, more desirably about 0.5% or more by mass and 3.0% or less by mass, and still more desirably about 0.7% or more by mass and 2.0% or less by mass. This makes it possible to obtain the coil part 10 having excellent magnetic characteristic while sufficiently binding particles of the soft magnetic powder to each other.

If necessary, various additives may be added to a mixture for any purpose.

Examples of the constituent material of the conductive wire 12 include a material having high conductivity, for example, a metal material containing Cu, Al, Ag, Au, Ni, or the like. If necessary, an insulation film may be provided on a surface of the conductive wire 12.

The shape of the dust core 11 is not limited to the ring shape shown in FIG. 1 and, for example, may be the shape of a ring with a portion missing, a shape in which the shaped in the longitudinal direction is linear, a sheet shape, a film shape, or the like.

The dust core 11, if necessary, may include a soft magnetic powder other than the soft magnetic powder according to the embodiment described above or a nonmagnetic powder.

### 3. 2. Closed Magnetic Circuit Type

Next, a coil part of a closed magnetic circuit type, which is an example of a magnetic element according to an embodiment, will be described.

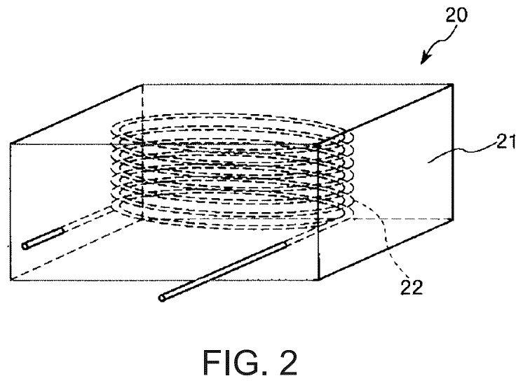

FIG. 2 is a transparent perspective view schematically showing a closed magnetic circuit type coil part.

Hereinafter, a closed magnetic circuit type coil part will be described, in the following description, differences from the toroidal type coil part will be mainly described, and the description of the same matters will be omitted.

A coil part 20 according to the present embodiment, as shown in FIG. 2, is obtained by embedding a conductive wire 22 formed into a coil shape within a dust core 21. That is, the coil part 20, which is a magnetic element, includes the dust core 21 containing the above-described soft magnetic powder, and is formed by molding the conductive wire 22 with the dust core 21. The dust core 21 includes the same configuration as the dust core 11 described above. Thus, it is possible to realize the dust core 21 of high density at low iron loss.

The coil part 20 having such a form is relatively easy to miniaturize. Therefore, when the coil part 20 is mounted on an electronic device or the like, it is possible to achieve high performance and miniaturization of the electronic device or the like.

Further, since the conductive wire 22 is embedded in the interior of the dust core 21, it is difficult for a gap to occur between the conductive wire 22 and the dust core 21. Therefore, to suppress vibration due to magnetostriction of the dust core 21, it is also possible to suppress the occurrence of noise associated with this vibration.

The shape of the dust core 21 is not limited to the shape shown in FIG. 2, and may be a sheet shape, a film shape, or the like.

The dust core 21, if necessary, may include a soft magnetic powder other than the soft magnetic powder according to the embodiment described above or a nonmagnetic powder.

### 4. Electronic Device

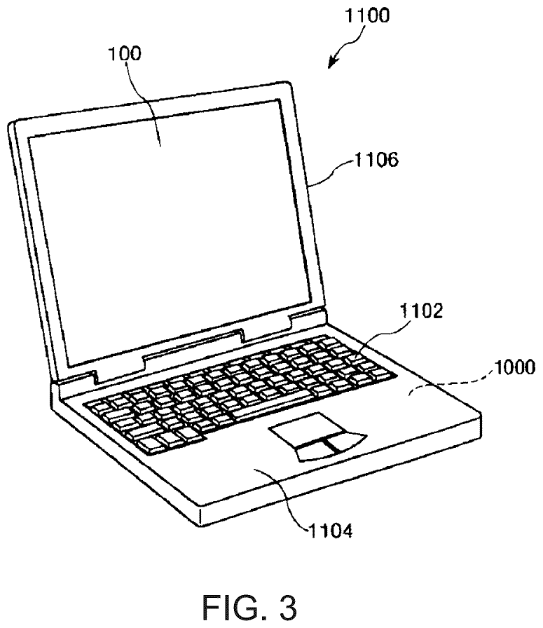

Next, electronic devices including a magnetic element according to an embodiment will be described with reference to FIGS. 3 to 5.

FIG. 3 is a perspective view showing a mobile type personal computer, which is an electronic device including a magnetic element according to an embodiment. A personal computer 1100 shown in FIG. 3 includes a main body section 1104 including a keyboard 1102, and a display unit 1106 including a display section 100. The display unit 1106 is rotatably supported on the main body section 1104 via a hinge structure section. In such a personal computer 1100, for example, a magnetic element 1000 such as a choke coil, an inductor, or a motor for a switching power supply is incorporated.

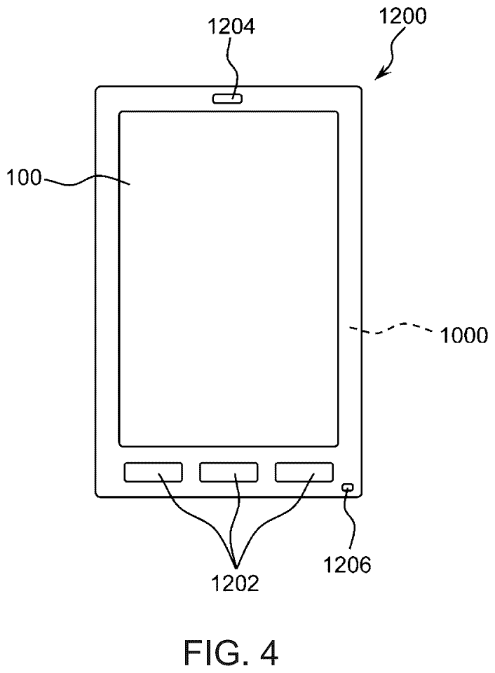

FIG. 4 is a plan view showing a smartphone, which is an electronic device including a magnetic element according to an embodiment. A smartphone 1200 shown in FIG. 4 includes a plurality of operation buttons 1202, an earpiece 1204, and a mouthpiece 1206. A display section 100 is arranged between the operation buttons 1202 and the earpiece 1204. In such a smartphone 1200, for example, the magnetic element 1000 such as an inductor, a noise filter, or a motor is incorporated.

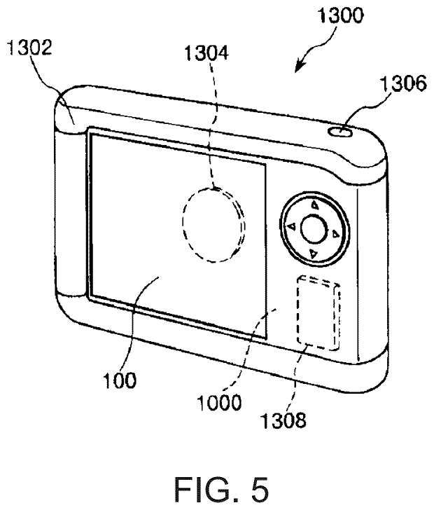

FIG. 5 is a perspective view showing a digital still camera, which is an electronic device including a magnetic element according to an embodiment. The digital still camera 1300 generates an imaging signal by photoelectrically converting a light image of a subject by an imaging element such as a charge coupled device (CCD).

The digital still camera 1300 shown in FIG. 5 includes the display section 100 provided on a rear surface of a case 1302. The display section 100 functions as a finder for displaying a subject as an electronic image. A light receiving unit 1304 including an optical lens, a CCD, and the like is provided on a front surface side of the case 1302, that is, on the rear surface side in the drawing.

When a photographer confirms a subject image displayed on the display section 100 and presses a shutter button 1306, an imaging signal of the CCD at that time is transferred to and stored in a memory 1308. Such a digital still camera 1300 also incorporates the magnetic element 1000 such as an inductor or a noise filter.

As the electronic device according to an embodiment, in addition to the personal computer of FIG. 3, the smartphone of FIG. 4, and the digital still camera of FIG. 5, other examples are, for example, a mobile phone, tablet terminal, timepiece, inkjet type ejection device such as an inkjet printer, laptop personal computer, television, video camera, video tape recorder, car navigation device, pager, electronic organizer, electronic dictionary, calculator, electronic game machine, word processor, workstation, video phone, television monitor for crime prevention, electronic binoculars, POS terminal, electronic thermometer, sphygmomanometer, blood glucose meter, electrocardiogram measurement device, ultrasound diagnostic apparatus, medical instrument such as an electronic endoscope, fish finder, various measurement devices, vehicle, aircraft, vessel instrumentation, vehicle control device, aircraft control equipment, railway vehicle control device, mobile control equipment such as ship control equipment, and flight simulator.

As described above, such an electronic device includes a magnetic element according to an embodiment. Thus, the effects of the magnetic element according to the embodiment that comprises a dust core of high density at low iron loss can be enjoyed, and it is possible to achieve high performance and miniaturization of an electronic device.

### 5. Effects Achieved by Embodiment

As described above, the soft magnetic powder according to the embodiment includes Fe as a main component; Si having a content of 2.5% or more by mass and 7.5% or less by mass; Cr having a content of 1.0% or more by mass and 10.0% or less by mass; Sn having a content of 0.05% or more by mass and 1.10% or less by mass, and impurities. The average particle size is 2.0 μm or more and 10.0 μm or less, and the average circularity of the particles is 0.80 or more and 0.95 or less.

According to such a configuration, a soft magnetic powder capable of producing a high density green compact with low iron loss is obtained that has a high filling property even at small particle sizes.

In the soft magnetic powder according to the embodiment, the oxygen content rate is 300 ppm or more and 3000 ppm or less.

According to such a configuration, a soft magnetic powder capable of producing a green compact having a high density and a suppressed eddy current loss is obtained.

In the soft magnetic powder according to the embodiment, the tapped density is 3.80 g/cm³ or more and 5.10 g/cm³ or less, and the specific surface area is 0.170 m²/g or more and 0.320 m²/g or less.

According to such a constitution, a soft magnetic powder having a good filling property is obtained in spite of having a small diameter. By this, a green compact having a lower iron loss and a higher density can be produced.

In the soft magnetic powder according to the embodiment, the coercive force is 12.0 [Oe] or less (955 [A/m] or less).

According to such a configuration, a green compact with suppressed hysteresis loss is obtained.

In the soft magnetic powder according to the embodiment, a green compact that is formed by powder compacting at a pressure of 294 MPa, has a density of 5.30 g/cm³ or more and 6.10 g/cm³ or less.

According to such a constitution, a soft magnetic powder having a particularly good filling property and relatively low difficulty in production can be obtained. By this, it is possible to produce a green compact having a higher density.

In the soft magnetic powder according to the embodiment, when the mass ratio of the content of Sn to the content of Cr is defined as Sn/Cr, the Sn/Cr is 0.02 or more and 0.30 or less.

According to such a configuration, the balance between the content of Cr and the content of Sn can be optimized. This makes it possible to achieve both an improvement in the filling property due to the particle shape and an improvement in the magnetic characteristic due to the optimization of the composition. As a result, a green compact having particularly good magnetic characteristic can be obtained.

In the soft magnetic powder according to the embodiment, the particle includes a plurality of crystal grains, and the number of crystal grains per unit area of a cross section of the particle is 0.10 [grains/(μm)²] or more and 0.45 [grains/(μm)²] or less.

According to such a configuration, it is possible to optimize the number density of crystal grains contained in the particles, as a result, it is possible to optimize the crystal grain size. By this, particles are appropriately deformed at the time of powder compacting, and a soft magnetic powder capable of producing a high-density green compact is obtained. The magnetic permeability depending on the crystal grain size is sufficiently high, and a soft magnetic powder with low eddy current loss can be obtained.

The dust core according to the embodiment includes the soft magnetic powder according to the embodiment. By this, the dust core having a high filling property of the soft magnetic powder and a high magnetic permeability can be obtained. The dust core that easily reduces the iron loss can be obtained.

The magnetic element according to the embodiment includes the dust core according to the embodiment. By this, a magnetic element with high performance and that is easy to miniaturize is obtained.

The electronic device according to the embodiment includes the magnetic element according to the embodiment. By this, it is possible to achieve high performance and miniaturization of the electronic device.

The soft magnetic powder, the dust core, the magnetic element, and the electronic device of the present disclosure have been described above based on the preferred embodiments, but the present disclosure is not limited thereto. For example, the shape of the dust core and the magnetic element is not limited to those shown, it may be any shape.

### Working Example

Next, specific working examples of the present disclosure will be described.

### 6. Production of Soft Magnetic Powder

### 6. 1. Sample No.1

First, a soft magnetic powder was obtained by a water atomization method. The composition of the obtained soft magnetic powder is as shown in Table 1. The production conditions of the soft magnetic powder by a water atomization method are as shown in Table 1.

For the obtained soft magnetic powder, the average particle size, the average circularity, the oxygen content rate, and the number of crystal grains per unit area were measured. The measurement results are shown in Table 1.

Further, as the production conditions of the soft magnetic powder, the difference between the casting temperature and the melting point, and the outer diameter of a thin flow of the molten metal are shown in Table 1.

### 6. 2. Sample No. 2 to 23

The soft magnetic powder was obtained in the same manner as in sample No. 1 except that the composition of the soft magnetic powder was changed as shown in Table 1, Table 2, or Table 3.

In Table 1 to Table 3, each sample No. of the soft magnetic powder, those corresponding to the present disclosure are referred to as “working example” while those not corresponding to the present disclosure are referred to as “comparative example”.

### 7. Evaluation of Soft Magnetic Powder

### 7. 1. Tapped Density of Soft Magnetic Powder

The tapped density of the soft magnetic powder of each sample No. was measured. The measurement results are shown in Table 1 to Table 3.

### 7. 2. Specific Surface Area of Soft Magnetic Powder

The specific surface area of the soft magnetic powder of each sample No. was measured. The measurement results are shown in Table 1 to Table 3.

### 7. 3. Coercive Force of Soft Magnetic Powder

The coercive force of the soft magnetic powder of each sample No. was measured. The measurement results are shown in Table 1 to Table 3.

### 7. 4. Density of Green Compact

Using the soft magnetic powder of each sample No., the green compact was produced as follows.

First, a soft magnetic powder, an epoxy resin (binder), and methyl ethyl ketone were mixed to obtain a mixed material. The addition amount of the epoxy resin was 2% by mass relative to the soft magnetic powder.

Next, the obtained mixed material was stirred and then dried by heating at a temperature of 150° C. for 30 minutes to obtain a dried body. Then, the dried body was passed through a sieve having an opening of 600 μm, and the dried body was ground to obtain a granulated powder.

Next, the obtained granulated powder was filled into a molding die, and a molded body was obtained based on the following molding conditions.
Molding method: press molding
Molded body shape: ring-shaped
Dimensions of molded body: outer diameter φ14 mm, inner diameter φ8 mm, thickness 3 mm.
Molding pressure: 294 MPa

Next, the binder in the molded body was cured by heating. By this, the green compact was obtained.

Next, the mass of the obtained green compact was measured, and the density of the green compact was calculated based on the measured mass and the volume of the molded body. The calculation results are shown in Table 1 to Table 3.

### 7. 5. Direct Current Superposition Characteristic of Green Compact

Each sample No. of green compacts produced using the soft magnetic powder was measured for direct current superposition characteristic. The measurement results are shown in Table 1 to Table 3.

### 7. 6. Iron Loss of Green Compact

The iron loss of the green compact produced using the soft magnetic powder of each sample No. was measured. The measurement conditions of the iron loss are as follows.
Measuring device: BH analyzer, SY-8258 manufactured by IWATSU ELECTRIC CO., LTD.
Measurement frequency: 900 kHz
Number of winding wire turns: 36 on primary side, 36 on secondary side
Winding wire diameter: 0.5 mm
Maximum magnetic flux density: 50 mT

Next, the measured iron loss was evaluated against the following evaluation reference. The evaluation results are shown in Table 1 to Table 3. The reference value in the following evaluation reference is the iron loss measured for the green compact of Sample No. 7 in the green compacts shown in Table 1 and Table 3, and the iron loss measured for the green compact of Sample No. 16 in the green compacts shown in Table 2.
A: Iron loss is 100% or less of reference value
B: Iron loss is more than 100% and 110% or less of the reference value
C: Iron loss is more than 110% of the reference value

TABLE 1

| | | CONFIGURATION OF | | | | | | | | | PRODUCTION |
|---|---|---|---|---|---|---|---|---|---|---|---|
| | | SOFT MAGNETIC POWDER | | | | | | | | | CONDITIONS |
| | | | | | | | | | | | DIFFER- |
| | | | | | | | | | | NUMBER | ENCE |
| | | | | | | | | | | OF | BETWEEN |
| | | | | | | | | | | CRYSTAL | CASTING |
| | | | | | | | AVERAGE | AVERAGE | | GRAINS | TEMPER- |
| | | | | | | | PARTICLE | CIRCU- | OXYGEN | PER UNIT | ATURE AND |
| | | COMPOSITION | | | | | SIZE OF | LARITY OF | CONTENT | AREA | MELTING |
| SAMPLE | | Fe | Si | Cr | Sn | Sn/Cr | POWDER | POWDER | RATE | GRAINS/ | POINT |
| No. | | % BY MASS | | | | — | μm | — | ppm | (μm)² | ° C. |
| No. 1 | WORKING | RE- | 3.5 | 4.5 | 0.05 | 0.011 | 9.8 | 0.83 | 980 | 0.147 | 260 |
| | EXAMPLE | MAIN- | | | | | | | | | |
| | | DER | | | | | | | | | |
| No. 2 | WORKING | RE- | 3.5 | 4.5 | 0.10 | 0.022 | 9.5 | 0.85 | 1020 | 0.160 | 280 |
| | EXAMPLE | MAIN- | | | | | | | | | |
| | | DER | | | | | | | | | |
| No. 3 | WORKING | RE- | 3.5 | 4.5 | 0.20 | 0.044 | 9.4 | 0.86 | 1050 | 0.185 | 300 |
| | EXAMPLE | MAIN- | | | | | | | | | |
| | | DER | | | | | | | | | |
| No. 4 | WORKING | RE- | 3.5 | 4.5 | 0.40 | [symbol] | 8.7 | 0.87 | 1120 | 0.209 | 290 |
| | EXAMPLE | MAIN- | | | | | | | | | |
| | | DER | | | | | | | | | |
| No. 5 | WORKING | RE- | 3.5 | 4.5 | 0.70 | 0.156 | 9.0 | 0.87 | 1320 | 0.245 | 280 |
| | EXAMPLE | MAIN- | | | | | | | | | |
| | | DER | | | | | | | | | |
| No. 6 | WORKING | RE- | 3.5 | 4.5 | 1.00 | 0.222 | 8.4 | 0.88 | 1700 | 0.281 | 260 |
| | EXAMPLE | MAIN- | | | | | | | | | |
| | | DER | | | | | | | | | |
| No. 7 | COMPAR- | RE- | 3.5 | 4.5 | 0.00 | 0.000 | 10.0 | 0.84 | 1080 | 0.134 | 250 |
| | ATIVE | MAIN- | | | | | | | | | |
| | EXAMPLE | DER | | | | | | | | | |
| No. 8 | COMPAR- | RE- | 3.0 | 4.5 | 0.02 | 0.004 | 9.9 | 0.84 | 890 | 0.138 | 250 |
| | ATIVE | MAIN- | | | | | | | | | |
| | EXAMPLE | DER | | | | | | | | | |
| No. 9 | COMPAR- | RE- | 3.5 | 4.5 | 1.30 | 0.289 | 7.8 | 0.89 | 4500 | 0.410 | 260 |
| | ATIVE | MAIN- | | | | | | | | | |
| | EXAMPLE | DER | | | | | | | | | |

| | | | EVALUATION OF SOFT MAGNETIC POWDER | | | | | |
|---|---|---|---|---|---|---|---|---|
| | | PRODUCTION | | | | | DIRECT | |
| | | CONDITIONS | | | | | CURRENT | |
| | | OUTER | | | | | SUPER- | |
| | | DIAMETER | | | | | POSITION | |
| | | OF THIN | | | | | CHARAC- | IRON |
| | | FLOW OF | | SPECIFIC | COER- | DENSITY | TERISTIC | LOSS OF |
| | | MOLTEN | TAPPED | SURFACE | CIVE | OF GREEN | OF GREEN | GREEN |
| SAMPLE | | METAL | DENSITY | AREA | FORCE | COMPACT | COMPACT | COMPACT |
| No. | | mm | g/cm³ | m²/g | Oe | g/cm³ | A/m | — |
| No. 1 | WORKING | 1.5 | 4.80 | 0.190 | 6.5 | 5.88 | 15500 | B |
| | EXAMPLE | | | | | | | |
| No. 2 | WORKING | 1.5 | 4.82 | 0.193 | 6.8 | 5.90 | 17500 | A |
| | EXAMPLE | | | | | | | |
| No. 3 | WORKING | 1.5 | [symbol] | 0.196 | [symbol] | 5.93 | [symbol] | A |
| | EXAMPLE | | | | | | | |
| No. 4 | WORKING | 1.5 | [symbol] | 0.250 | 6.7 | 5.91 | 19000 | A |
| | EXAMPLE | | | | | | | |
| No. 5 | WORKING | 1.5 | 4.84 | 0.265 | 6.7 | 5.92 | 20000 | A |
| | EXAMPLE | | | | | | | |
| No. 6 | WORKING | 1.5 | 4.85 | 0.280 | [symbol] | 5.93 | 21000 | A |
| | EXAMPLE | | | | | | | |
| No. 7 | COMPAR- | 1.5 | 4.75 | 0.171 | 6.3 | 5.53 | 13500 | — |
| | ATIVE | | | | | | | |
| | EXAMPLE | | | | | | | |
| No. 8 | COMPAR- | 1.5 | [symbol] | 0.182 | [symbol] | 5.55 | 14000 | A |
| | ATIVE | | | | | | | |
| | EXAMPLE | | | | | | | |
| No. 9 | COMPAR- | 1.5 | 4.93 | 0.330 | 7.4 | 5.29 | 22500 | B |
| | ATIVE | | | | | | | |
| | EXAMPLE | | | | | | | |

[symbol]

indicates data missing or illegible when filed

TABLE 2

| | | CONFIGURATION OF | | | | | | | | | PRODUCTION |
|---|---|---|---|---|---|---|---|---|---|---|---|
| | | SOFT MAGNETIC POWDER | | | | | | | | | CONDITIONS |
| | | | | | | | | | | | DIFFER- |
| | | | | | | | | | | NUMBER | ENCE |
| | | | | | | | | | | OF | BETWEEN |
| | | | | | | | | AVERAGE | | CRYSTAL | CASTING |
| | | | | | | | AVERAGE | CIRCU- | | GRAINS | TEMPER- |
| | | | | | | | PARTICLE | LARITY | OXYGEN | PER UNIT | ATURE AND |
| | | COMPOSITION | | | | | SIZE OF | OF | CONTENT | AREA | MELTING |
| SAMPLE | | Fe | Si | Cr | Sn | Sn/Cr | POWDER | POWDER | RATE | GRAINS/ | POINT |
| No | | % BY MASS | | | | — | μm | — | ppm | (μm)² | ° C. |
| No. 10 | WORKING | RE- | 3.5 | 4.5 | 0.15 | 0.033 | 2.2 | 0.85 | 2500 | 0.172 | [symbol] |
| | EXAMPLE | MAIN- | | | | | | | | | |
| | | DER | | | | | | | | | |
| No. 11 | WORKING | RE- | 3.5 | 4.5 | 0.54 | 0.120 | 5.5 | 0.88 | 2000 | 0.220 | 290 |
| | EXAMPLE | MAIN- | | | | | | | | | |
| | | DER | | | | | | | | | |
| No. 12 | WORKING | RE- | 3.5 | 1.5 | 0.15 | 0.100 | 2.8 | 0.81 | 2400 | 0.210 | 260 |
| | EXAMPLE | MAIN- | | | | | | | | | |
| | | DER | | | | | | | | | |
| No. 13 | WORKING | RE- | 3.5 | [symbol] | 0.40 | 0.267 | 4.3 | 0.83 | 2100 | 0.345 | 210 |
| | EXAMPLE | MAIN- | | | | | | | | | |
| | | DER | | | | | | | | | |
| No. 14 | COMPAR- | RE- | 3.5 | 4.5 | 0.20 | 0.044 | [symbol] | 0.80 | [symbol] | 0.230 | [symbol] |
| | ATIVE | MAIN- | | | | | | | | | |
| | EXAMPLE | DER | | | | | | | | | |
| No. 15 | COMPAR- | RE- | 3.0 | 4.5 | 0.20 | 0.044 | 11.5 | 0.88 | 1100 | [symbol] | [symbol] |
| | ATIVE | MAIN- | | | | | | | | | |
| | EXAMPLE | DER | | | | | | | | | |
| No. 16 | COMPAR- | RE- | 3.5 | 4.5 | 0.10 | 0.022 | 2.8 | 0.77 | 1050 | 0.158 | [symbol] |
| | ATIVE | MAIN- | | | | | | | | | |
| | EXAMPLE | DER | | | | | | | | | |

| | | PRODUCTION | EVALUATION OF SOFT MAGNETIC POWDER | | | | | |
|---|---|---|---|---|---|---|---|---|
| | | CONDITIONS | | | | | DIRECT | |
| | | OUTER | | | | | CURRENT | |
| | | DIAM- | | | | | SUPER- | |
| | | ETER | | | | | POSITION | |
| | | OF THIN | | | | | CHARAC- | IRON |
| | | FLOW OF | | SPECIFIC | COER- | DENSITY | TERISTIC | LOSS OF |
| | | MOLTEN | TAPPED | SURFACE | CIVE | OF GREEN | OF GREEN | GREEN |
| SAMPLE | | METAL | DENSITY | AREA | FORCE | COMPACT | COMPACT | COMPACT |
| No | | mm | g/cm³ | m²/g | Oe | g/cm³ | A/m | — |
| No. 10 | WORKING | 1.0 | 4.10 | 0.315 | [symbol] | [symbol] | [symbol] | A |
| | EXAMPLE | | | | | | | |
| No. 11 | WORKING | 1.0 | 4.21 | 0.285 | [symbol] | 5.78 | 19500 | A |
| | EXAMPLE | | | | | | | |
| No. 12 | WORKING | 1.0 | 4.23 | 0.304 | 7.5 | 5.64 | 18500 | A |
| | EXAMPLE | | | | | | | |
| No. 13 | WORKING | 1.0 | 4.25 | 0.294 | 7.0 | 5.74 | [symbol] | A |
| | EXAMPLE | | | | | | | |
| No. 14 | COMPAR- | 0.5 | 3.25 | [symbol] | 8.5 | 4.80 | 12500 | A |
| | ATIVE | | | | | | | |
| | EXAMPLE | | | | | | | |
| No. 15 | COMPAR- | 2.5 | [symbol] | 0.245 | 6.6 | 5.89 | [symbol] | C |
| | ATIVE | | | | | | | |
| | EXAMPLE | | | | | | | |
| No. 16 | COMPAR- | 1.0 | 3.65 | 0.305 | 7.5 | 5.21 | [symbol] | — |
| | ATIVE | | | | | | | |
| | EXAMPLE | | | | | | | |

[symbol]

indicates data missing or illegible when filed

TABLE 3

| | | CONFIGURATION OF | | | | | | | | | |
|---|---|---|---|---|---|---|---|---|---|---|---|
| | | SOFT MAGNETIC POWDER | | | | | | | | | PRODUCTION |
| | | | | | | | | | | | CONDITIONS |
| | | | | | | | | | | | DIFFER- |
| | | | | | | | | | | NUMBER | ENCE |
| | | | | | | | | | | OF | BETWEEN |
| | | | | | | | | AVERAGE | | CRYSTAL | CASTING |
| | | | | | | | AVERAGE | CIRCU- | | GRAINS | TEMPER- |
| | | | | | | | PARTICLE | LARITY | OXYGEN | PER UNIT | ATURE AND |
| | | COMPOSITION | | | | | SIZE OF | OF | CONTENT | AREA | MELTING |
| SAMPLE | | Fe | Si | Cr | Sn | Sn/Cr | POWDER | POWDER | RATE | GRAINS/ | POINT |
| No. | | % BY MASS | | | | — | μm | — | ppm | (μm)² | ° C. |
| No. 17 | WORKING | RE- | 2.5 | 4.5 | 0.20 | 0.044 | 8.4 | 0.85 | 1080 | 0.184 | 310 |
| | EXAMPLE | MAIN- | | | | | | | | | |
| | | DER | | | | | | | | | |
| No. 18 | WORKING | RE- | 5.0 | 4.5 | 0.20 | 0.044 | [symbol] | 0.82 | 1200 | 0.203 | 300 |
| | EXAMPLE | MAIN- | | | | | | | | | |
| | | DER | | | | | | | | | |
| No. 19 | WORKING | RE- | 7.0 | 4.5 | 0.20 | 0.044 | [symbol] | 0.82 | 1200 | 0.221 | 300 |
| | EXAMPLE | MAIN- | | | | | | | | | |
| | | DER | | | | | | | | | |
| No. 20 | WORKING | RE- | 3.5 | 1.5 | 0.20 | 0.133 | 8.2 | 0.84 | 1100 | 0.210 | 300 |
| | EXAMPLE | MAIN- | | | | | | | | | |
| | | DER | | | | | | | | | |
| No. 21 | WORKING | RE- | 3.5 | 2.5 | 0.20 | 0.080 | [symbol] | 0.81 | 1220 | 0.207 | 290 |
| | EXAMPLE | MAIN- | | | | | | | | | |
| | | DER | | | | | | | | | |
| No. 22 | WORKING | RE- | 3.5 | [symbol] | 0.20 | 0.031 | [symbol] | 0.85 | 1100 | 0.170 | 290 |
| | EXAMPLE | MAIN- | | | | | | | | | |
| | | DER | | | | | | | | | |
| No. 23 | WORKING | RE- | 3.5 | 8.5 | 0.20 | 0.024 | 6.0 | [symbol] | 1080 | [symbol] | 290 |
| | EXAMPLE | MAIN- | | | | | | | | | |
| | | DER | | | | | | | | | |

| | | PRODUCTION | EVALUATION OF SOFT MAGNETIC POWDER | | | | | |
|---|---|---|---|---|---|---|---|---|
| | | CONDITIONS | | | | | DIRECT | |
| | | OUTER | | | | | CURRENT | |
| | | DIAM- | | | | | SUPER- | |
| | | ETER | | | | | POSITION | |
| | | OF THIN | | | | | CHARAC- | IRON |
| | | FLOW OF | | SPECIFIC | COER- | DENSITY | TERISTIC | LOSS OF |
| | | MOLTEN | TAPPED | SURFACE | CIVE | OF GREEN | OF GREEN | GREEN |
| SAMPLE | | METAL | DENSITY | AREA | FORCE | COMPACT | COMPACT | COMPACT |
| No. | | mm | g/cm³ | m²/g | Oe | g/cm³ | A/m | — |
| No. 17 | WORKING | 1.0 | 4.62 | 0.195 | [symbol] | 5.90 | 17000 | A |
| | EXAMPLE | | | | | | | |
| No. 18 | WORKING | 1.0 | 4.60 | 0.192 | [symbol] | [symbol] | [symbol] | A |
| | EXAMPLE | | | | | | | |
| No. 19 | WORKING | 1.0 | 4.60 | 0.191 | 7.0 | 5.88 | [symbol] | A |
| | EXAMPLE | | | | | | | |
| No. 20 | WORKING | 1.0 | [symbol] | 0.189 | 6.8 | [symbol] | [symbol] | A |
| | EXAMPLE | | | | | | | |
| No. 21 | WORKING | 1.0 | 4.57 | 0.188 | 7.0 | 5.85 | [symbol] | A |
| | EXAMPLE | | | | | | | |
| No. 22 | WORKING | 1.0 | [symbol] | 0.195 | 7.4 | 5.90 | 17000 | B |
| | EXAMPLE | | | | | | | |
| No. 23 | WORKING | 1.0 | 4.64 | [symbol] | 7.6 | [symbol] | 18000 | B |
| | EXAMPLE | | | | | | | |

[symbol]

indicates data missing or illegible when filed

As shown in Table 1 to Table 3, it was confirmed that the soft magnetic powder of each working example had a high tapped density and a small specific surface area even when the particle size was small, and thus had a high filling property. It was also found that a green compact with low iron loss and high density can be obtained by using the soft magnetic powder of each working example. Furthermore, the green compact has a relatively low coercive force, and it was also found to have a high direct current superposition characteristic. Further, by optimizing the number of crystal grains per unit area of the particle cross section of the soft magnetic powder, it was possible to achieve a low iron loss and high density of the green compact.

In contrast, in the green compact produced using the soft magnetic powder of each comparative example, it was not possible to achieve a low iron loss or high density. It was also found that the direct current superposition characteristic was low.

What is claimed is:

1. A soft magnetic powder comprising:
Fe as a main component;
Si having a content of 2.5% or more by mass and 7.5% or less by mass;
Cr having a content of 1.0% or more by mass and 10.0% or less by mass;
Sn having a content of 0.05% or more by mass and 1.10% or less by mass; and
impurities, wherein
an average particle size is 2.0 μm or more and 10.0 μm or less and
an average circularity of particles is 0.80 or more and 0.95 or less.

2. The soft magnetic powder according to claim 1, wherein
an oxygen content rate is 300 ppm or more and 3000 ppm or less.

3. The soft magnetic powder according to claim 1, wherein
a tapped density is 3.80 g/cm³ or more and 5.10 g/cm³ or less and
a specific surface area is 0.170 m²/g or more and 0.320 m²/g or less.

4. The soft magnetic powder according to claim 1, wherein
a coercive force is 12.0 [Oe] or less (955 [A/m] or less).

5. The soft magnetic powder according to claim 1, wherein
a density of a green compact formed by powder compaction at a pressure of 294 MPa is 5.30 g/cm³ or more and 6.10 g/cm³ or less.

6. The soft magnetic powder according to claim 1, wherein
when a mass ratio of content of Sn to content of Cr is defined as Sn/Cr, the Sn/Cr is 0.02 or more and 0.30 or less.

7. The soft magnetic powder according to claim 1, wherein
the particle includes a plurality of crystal grains and
a number of the crystal grains per unit area of a cross section of the particle is 0.10 [grains/(μm)²] or more and 0.45 [grains/(μm)²] or less.

8. A dust core comprising:
the soft magnetic powder according to claim 1.

9. A magnetic element comprising:
the dust core according to claim 8.

10. An electronic device comprising:
the magnetic element according to claim 9.
